(19) United States
(12) Patent Application Publication
(10) Pub. No.: US 2007/0042746 A1
(43) Pub. Date: Feb. 22, 2007

(54) Cellular phone housing with retractable microphone/earpiece assembly

(76) Inventor: Thomas E. Beard, Healdsburg, CA (US)

Correspondence Address: STAINBROOK & STAINBROOK, LLP, 3558 ROUND BARN BLVD., SUITE 203, SANTA ROSA, CA, 95403, US

(21) Appl. No.: 11/207,247

(22) Filed: Aug. 19, 2005

(51) Int. Cl. H04B 1/08

(52) U.S. Cl. 455/347

(57) ABSTRACT

A cellular telephone housing with a retractable microphone or earpiece component. The cellular telephone housing lends itself to styling in the shape of a guitar body, while the retractable microphone or earpiece is shaped like a guitar neck. The retractable assembly assumes a position coplanar to the functional face of the cellular phone when in use in the fully extended position, and folds away into a channel in the back of the cellular telephone housing body when fully retracted. The combination of features provides the user with a small profile cellular telephone with a distinctive style.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to cellular telephone housings, and more specifically to a cellular telephone housing with a novel fold out element that can function as either a speaker for an earpiece or a microphone for a mouthpiece.

### BACKGROUND INFORMATION AND DISCUSSION OF RELATED ART

The telephone is now ubiquitous throughout the world. Furtmermore, radio and cellular phone technology is now nearly ubiquitous in the industrialized world. The first radio telephones were large and unwieldy, and used primarily in military communications. As radio telephone technology evolved, the technology became available to the public. However, the phone apparatus was still large and generally required a wired connection to a power source located in, for example, a vehicle. The advancement of cellular network technology and the designation of more frequencies for cellular phone use has made the cellular telephone more accessible to the general public, and with that step came an immediate demand for increased coverage, improved performance in signal reception and transmission, improved portability of the handset, and increased functionality. Industry was not slow to respond. Now cell phones now work as wireless voice communication devices, digital cameras and image viewers, MP3 players, on-line gaming devices, PDAs, GSM/GPRS devices, text messaging devices, and so forth. Industry clearly sees manifold possibilities in the roles that handheld cell phones can play in our lives, and with the inventive energy now being directed at cell phone technology, we shouldn't be surprised to have the handheld phone soon cooking our dinners.

In addition to the exotic functions now performed by the handheld, the compactness, styling, and elegance of cellular telephone housing has also become important to the customer, and thus to the manufacturers and the supply chains for portable telephones. Consumers prefer a housing that reflects their personal tastes, style preferences, and possibly even communicates something about their hobbies and interests. Manufacturers desire distinctive styling to provide a functional container for the operative circuitry and a framework for branding. Distributors desire a distinctive styling to distinguish themselves in the marketplace. However, creating a style depends upon, and relates intimately to, the functionality of the cell phone itself, and providing an ergonomically sound and fully functional phone, with style as well, can be challenging.

Several approaches to addressing the size and appearance of the telephone have been undertaken, ranging from the development of a clamshell “flip phone” by Motorola to telescoping antennas or knuckle swivel antennas. Exemplary prior art includes:

U.S. Pat. No. 5,218,370, to Blaese, describes a portable telephone comprising a telephone housing, a connection member having a longitudinal axis attached to said housing and communicating outwardly therefrom, an antenna carried on the connection member, and a pivot system associated with the connection member to permit the antenna to swivel in a plane perpendicular to the longitudinal axis of the outer end of the connection member.

U.S. Pat. No. 5,717,408, assigned to Centurion Intl., Inc., describes a retractable antenna for use with a cellular telephone wherein the retractable antenna is removably mounted on the upper end of the telephone.

U.S. Pat. No. 6,075,489, assigned to Centurion Intl, Inc., describes a retractable antenna provided for a wireless communication device such as a wireless modem, two-way radio, cellular telephone, etc., wherein the extended length of the antenna is greater than the height of the telephone housing. The antenna includes components which are slidably mounted with respect to one another so that the antenna may be collapsed and retracted within the telephone housing.

U.S. Pat. No. 5,151,946, assigned to Technophone Limited, details a compact portable telephone comprising a housing having a main body and an extending sleeve-like portion mounted for longitudinal slidable movement between a retracted position when not in use, and an extended position for use.

U.S. Pat. No. 5,440,629, to Gray, describes a portable telephone handset construction having a chassis to which is slidably assembled an end closure which is collapsible to a position for protecting a selected portion of said chassis from contact and impact by other objects and to minimize its contamination by dust and other debris.

U.S. Pat. No. 4,179,591, to Becker, describes a decorative telephone housing in the form of a rectangular, hollow shell having top and side walls and open at the bottom, the shell partially enclosing an elongated bar pivoted at one end within the shell and extending across the interior with its free end protruding through an opening in a side wall of the shell, and a cradle for a handset fixed to the free end of the bar outside of the shell.

U.S. Pat. No. 5,768,370, to Maata, et al, describes a display system providing a portable telephone with a plurality of distinctive appearances. An overlying cover is removably attachable to a telephone housing which includes operating buttons and an indicia panel.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

What is needed is a cellular telephone housing that addresses the customer needs for compactness that also provides a unique ability to make a statement about personal style and interests. The present invention addresses those needs by integrating functional elements with aesthetic and styling elements in a housing configuration made possible by a pivotally retractable mouthpiece or earpiece that also functions as the phone's antenna. This reduces the overall dimensions of the cellular telephone.

### BRIEF SUMMARY OF THE INVENTION

The present invention is a cellular telephone housing with a retractable microphone or earpiece component combined with the phone antenna. In one particularly style, the cellular telephone housing is shaped like a guitar body, while the retractable microphone or earpiece/antenna is shaped like a guitar neck. The combination of features provides the user with a small profile cellular telephone with a distinctive style.

According to the invention, the cellular telephone housing has a housing body front panel containing a plurality of apertures that accommodate function buttons commonly found on cellular telephones. In one preferred embodiment, the housing body front panel has parallel rows of small ovoid apertures to accommodate the keypad of a telephone positioned in approximately the lower third of the housing body front panel. Positioned slightly above the parallel rows of apertures is an oblong ovoid aperture, accommodating a larger function button. The upper third of the housing body front panel contains a rectangular window to facilitate the viewing of a Liquid Crystal Display (LCD) or similar message/text screen commonly present on modern cellular telephones. The housing body front panel may optionally contain other apertures to accommodate other function buttons for a cellular telephone. A housing body back panel is attached to the housing body front panel by a housing body left panel, and housing body right panel, a housing body top panel and a housing body bottom panel. The housing body bottom panel contains an aperture for the connection of cellular telephone accessories. The housing body back panel mirrors the general shape of the housing body front panel. The housing body back panel contains a longitudinal groove that bisects the housing body back panel, traveling its entire length. The housing body back panel and the housing body top panel combine to form a receptacle that conforms to a shape that is substantially a three quarter disc having a left side and a right side on the housing body top panel, positioned at approximately the mid point of the housing body top panel. The right and left sides of the receptacle have top edges that are essentially perpendicular to the plane of the housing back panel, then slope downward gradually as they meet the intersection of the housing body top panel and the housing body back panel. The receptacle is completed with a planar surface that originates on the housing body front panel and intersects the left and right sides of the receptacle, terminating at the same height as the left and right sides of the receptacle. The receptacle additionally has two mirrored mounting apertures through the left and right sides.

A retractable microphone or earpiece and antenna combination (termed the “retractable assembly” herein) lends itself to styling in the general shape of a guitar neck having two ends, a front, and a back. The retractable assembly front generally resembles a guitar fret board. When employed as a microphone, a transceiver which is a microphone is inserted into the free end and the rotational end assumes an essentially discoid shape which is machined to fit into the receptacle on the housing body top side panel. The discoid rotational end of the microphone assembly additionally has a hole in the rotational center of the disc, which matches the mounting apertures on the receptacle. The rotational end of the retractable assembly additionally has a notch in the edge of the discoid portion that serves as a stop and a contact activation point for the retractable assembly. When employed as an earpiece, a speaker rather than a microphone is disposed in the free end.

When pivotally attached to the cellular phone housing body, the retractable assembly swings radially approximately 180°, from a position in which the retractable assembly is inserted into the longitudinal groove in the housing body back panel, assuming an essentially flush fit with the longitudinal groove in the housing, to a fully extended position in which the retractable assembly front assumes a coplanar position with respect to the housing body front panel.

In another embodiment of the invention herein, a face plate cover is attached to the housing body front panel with a hinge. The face plate may contain a plurality of functional buttons and an LCD screen. The face plate cover lifts to reveal parallel rows of small ovoid apertures to accommodate the keypad of a telephone positioned in approximately the lower third of the housing body front panel.

It will be obvious to those with skill in the art that the cellular phone housing body of the present invention as depicted in the attached drawings herein need not assume any particular guitar body design. In fact, it can be designed to reflect any of a number of distinctive guitar body styles. Indeed, the cell phone housing of the present invention provides the physical scaffolding for a number of elegant designs, all of which derive from the unique retractable assembly which plays the dual role of a speaker or microphone and an antenna.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty that characterize the invention are pointed out with particularity in the claims annexed to and forming part of this disclosure. The invention does not reside in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a front perspective view of a first preferred embodiment of the cellular phone housing of the present invention, showing the retractable [microphone/speaker] assembly in a retracted position;

FIG. 2 is a back perspective view thereof;

FIG. 3 is a front perspective view of the cellular phone housing with the retractable assembly in an extended position;

FIG. 4 is a is a back perspective view thereof;

FIG. 5 is a side view of the cellular phone housing showing the full extension arc of the retractable assembly, and with dashed lines showing the semi-retracted position of the retractable assembly;

FIG. 6 is a partial cross-section view showing details of the rotational end of the microphone/speaker assembly in the receptacle, as taken along Section 6-6 of FIG. 7;

FIG. 7 is a is a front view of the cellular phone housing of FIGS. 1-6, showing the microphone/speaker assembly in the extended position.

FIG. 8 is a front perspective view of a second preferred embodiment of the cellular phone housing of the present invention, showing the microphone/speaker assembly in a retracted position;

FIG. 9 is a back perspective view thereof;

FIG. 10 is a front perspective view thereof, showing the microphone/speaker assembly extended.

FIG. 11 is a back perspective view thereof showing the microphone/speaker assembly extended;

FIG. 12 is a front perspective view thereof showing the microphone/earipiece assembly extended and the face plate cover in the open position;

FIG. 13 is a back perspective view thereof;

FIG. 14 is an exploded perspective view of a third preferred embodiment of the cellular phone housing of the present invention, showing the structural and operational elements comprising the attachment of the microphone/speaker assembly to the housing body;

FIG. 15 is a partial cross-sectional front view in elevation of the third preferred embodiment;

FIG. 15A, is a removed sectional front view showing details of the pivotal electrical connection between the retractable assembly and the housing body of the third preferred embodiment, as taken along sectional view line 15A-15A;

FIG. 16 is a side view in elevation of the third preferred embodiment; and

FIG. 16A is a removed sectional side view showing details of the pivotal electrical connection between the retractable assembly and the housing body of the third preferred embodiment, as taken along sectional view line 16A-16A.

### DRAWING REFERENCE NUMERALS

100 cellular phone housing

102 housing body

105 housing body front panel

110 generally ovoid apertures

115 additional ovoid apertures

120 oblong ovoid aperture

125 rectangular window

130 housing body right panel

135 first triangular aperture

140 housing body bottom side panel

145 accessory aperture

200 housing body back panel

205 housing body top side panel

210 housing body left side panel

215 second triangular aperture

220 longitudinal channel

225 retractable assembly receptacle

225a, 225b, left and rights sides, respectively [of retractable assembly receptacle 225]

230 mounting apertures

235 rectractable assembly

237 front side [of retractable assembly]

240 transducer (either speaker or microphone)

245 free end

250 rotational end

255 notch

260 parallel tracking grooves

600 stop-contact pin

605 tracking pin

610 mounting hole

800 second preferred embodiment

805 face plate

810 housing body front panel

815 hinge assembly

820 liquid crystal display

825 exterior function buttons

830 large exterior function button

835 retractable assembly

840 longitudinal channel

850 housing body back panel

860 face plate underside

865 second liquid crystal display

870 apertures

875 interior function buttons

880 large aperture

885 large interior function button

900 third preferred embodiment of cellular phone housing

910 housing body

915 pivot pin hole

920 antenna

925 microphone/speaker

930 slide block detent

935 retractable assembly

940 domed end of slide block detent

945 notches

950 slip rings

950a/950b outboard slip rings

950c center slip ring

955 retractable assembly base

955a/955b sides of retractable assembly base

955c slip ring slot

957 slide block pocket

960 springs

965 conductors

970 free end of retractable assembly

975 slide block contacts

980 microphone/speaker

985 housing body front panel

990 hand strap

1000 retractable assembly receptacle

### DETAILED DESCRIPTION OF THE INVENTION

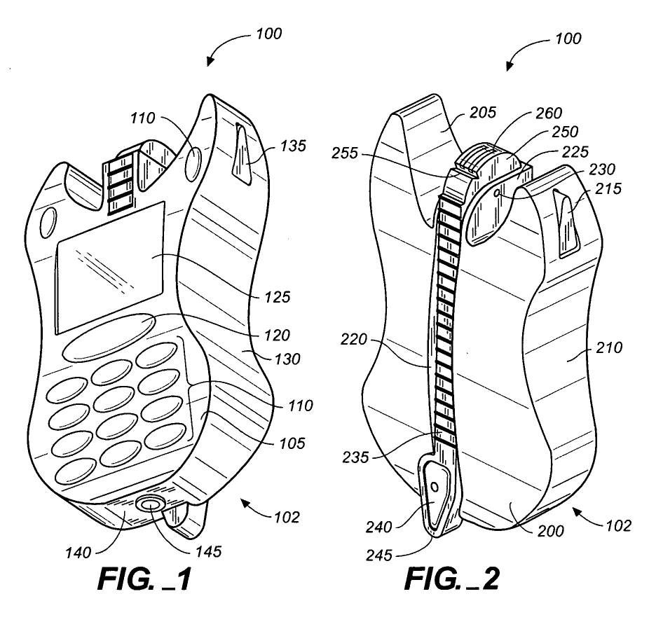

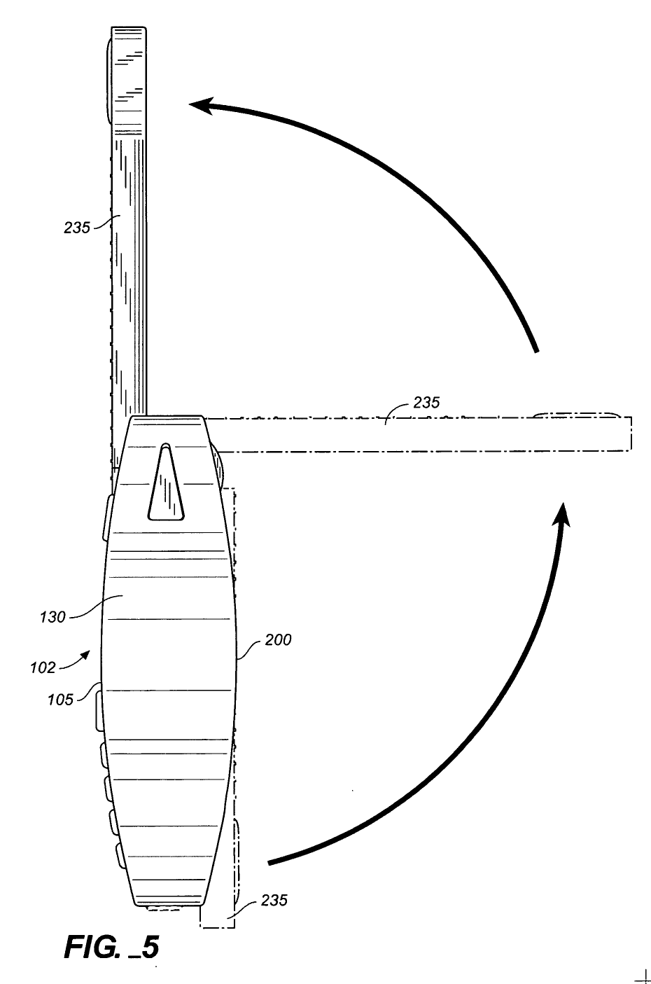

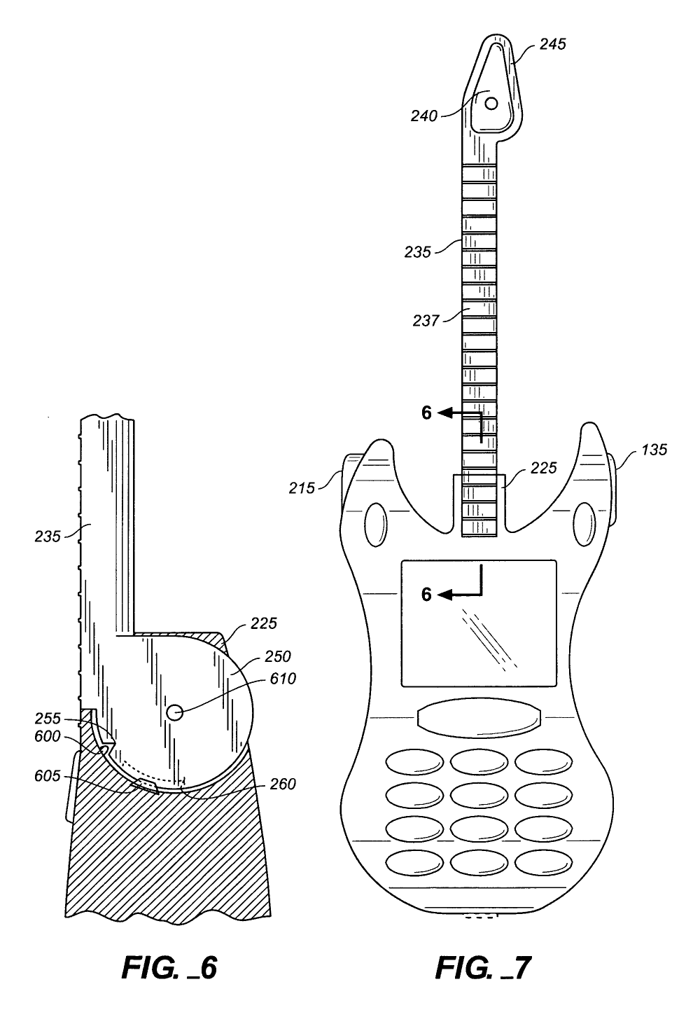

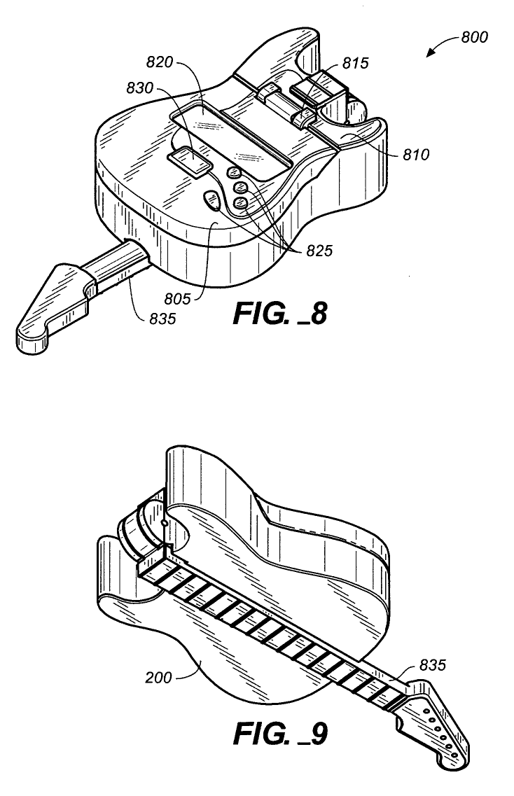

Referring now to FIGS. 1 through 7, wherein like reference numerals refer to like components in the various views, FIG. 1 is a is a front perspective view of a first preferred embodiment of the cellular phone housing 100 of the present invention. The cellular telephone housing 100 generally includes a housing body 102 and a retractable assembly 235, which includes a transducer and circuitry to support either a speaker or a microphone, according to design and/or user preferences. The housing body includes a housing body front panel 105, containing a plurality of apertures 110, preferably in parallel rows and having a generally ovoid shape. These ovoid apertures accommodate the function buttons commonly found on cellular telephones. Additional ovoid apertures 115 appear in the uppermost portion of the housing body front panel 105. Positioned slightly above the rows of apertures is another aperture 120, again preferably an oblong ovoid aperture, for accommodating a larger function button. A clear rectangular window 125 is located in the top portion of the housing body front panel 105, to facilitate the viewing of a liquid crystal display (LCD) or similar message/text screen commonly present on modern cellular telephones. Conjoined to the housing body front panel 105 is a housing body right panel 130, having a first triangular aperture 135 in the upper portion of the housing body to accommodate a function button. A housing body bottom panel 140 is conjoined to the housing body front panel 105 and the housing body right panel 130. An accessory aperture 145 is centrally located in the housing body bottom panel.

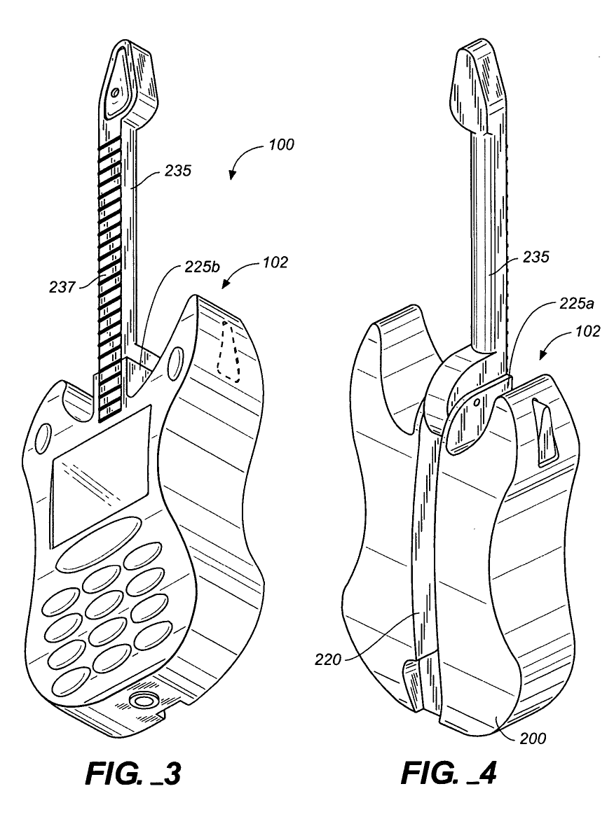

In the retracted position, the retractable assembly coplanar with the housing body back panel 200, and the housing body back panel 200. FIG. 2 shows the retractable assembly integral with or conjoined to the housing body top side panel 205 and the housing body left side panel 210. The housing body left side panel 210 has a second triangular aperture 215 in the upper portion to accommodate a function button. The housing body back panel 200 has a longitudinal channel 220 that generally bisects the housing body back panel 200. The housing body back panel 200 and the housing body top side panel 205 combine to form a receptacle 225 for pivotal attachment of the retractable assembly. The retractable assembly receptacle 225 conforms to a shape that is substantially a three-quarter disc having a left side 225a and a right side 225b, positioned at approximately the mid point of the housing body top side panel 205. The right and left sides of the receptacle 225 have top edges that are substantially perpendicular to the plane of the housing back panel 200, then curve or slope gradually downward as they converge with the intersection of the housing body top panel 205 and the housing body back panel 200. The receptacle 225 additionally has two mirrored mounting apertures 230 through the left and right sides which match a centrally positioned mounting hole 610 in the rotational end 250 of the retractable assembly 235 for insertion of a pivot pin [not shown] to provide a pivotal connection of the retractable assembly to the housing body.

The rectractable assembly 235 preferably simulates a guitar neck with a free end, an end connected to the [guitar] housing body, and a front side 237 that resembles a guitar fret board. A transducer 240 which may be either a microphone, or, alternatively, a speaker, is inserted into the free end 245, and the rotational end 250 assumes an essentially discoid shape which is machined to fit into the receptacle 225 on the housing body top panel 205. Referring now to FIG. 6, the rotational end 250 has a notch 255 in the edge of the discoid rotational end 250 that serves as a stop and a contact activation point for the retractable assembly 235. The rotational end 250 of the retractable assembly 235 has parallel tracking grooves 260 that allow stable travel while rotation occurs. Notch 255 contacts a stop-contact pin 600 when the retractable assembly is in the fully extended position. A dashed line represents one of the parallel tracking grooves 260 and a tracking pin 605 which allows smooth rotation of the retractable assembly 235.

Referring now to FIGS. 8-13, these views collectively show a second preferred embodiment 800 of the cellular telephone housing of the present invention. FIGS. 8 and 9 are front and rear perspective views, respectivelly, showing the apparatus with its retractable assembly 835 in a retracted position. This embodiment includes a face plate 805, hingeably attached to the housing body front panel 810 with a hinge assembly 815 at approximately the top of the housing body front panel. The face plate 805 has a small liquid crystal display 820 or other similar text display medium inset into the face plate. Additionally there are a plurality of exterior function buttons 825 inset below the liquid crystal display 820. An exterior large function button 830 is also inset below the liquid crystal display. The housing body front panel 810 recesses to allow the face plate 805 to assume a coplanar position with respect to the approximate the top of the housing body front panel. The structural and operational elements of this embodiment that permit rotational retraction of the retractable assembly 835 are identical to those of the first preferred embodiment.

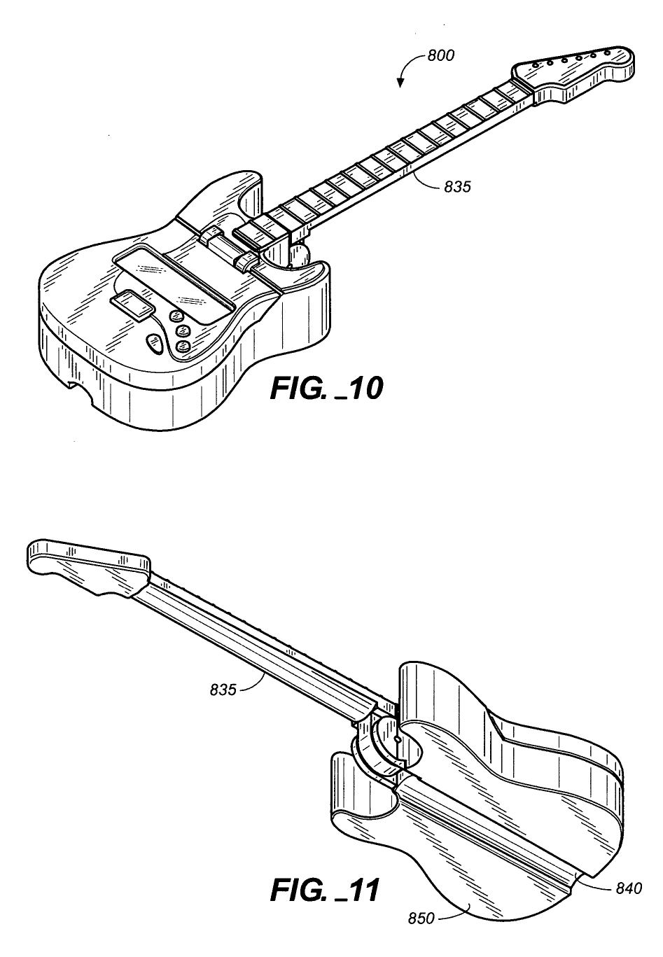

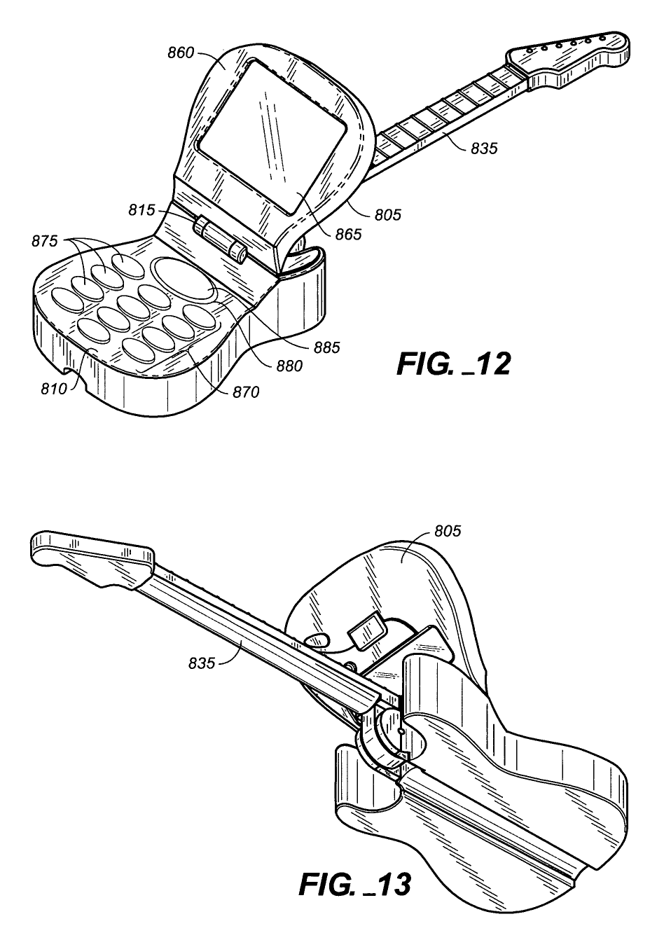

FIGS. 10 and 11 are front and rear perspective views, respectively, of the second preferred embodiment showing the retractable assembly 835 in a fully extended position. The longitudinal channel 840 is clearly visible in the housing body back panel 850.

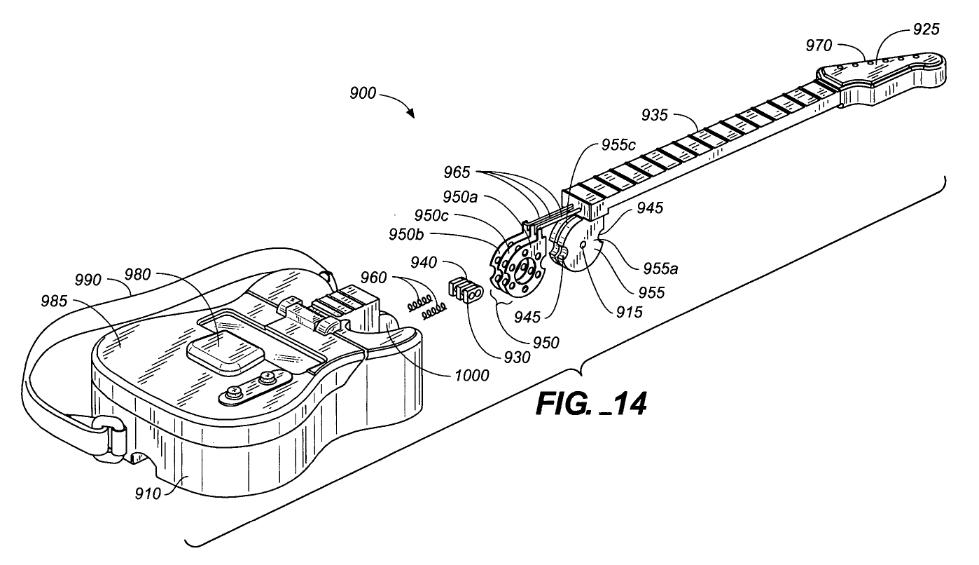

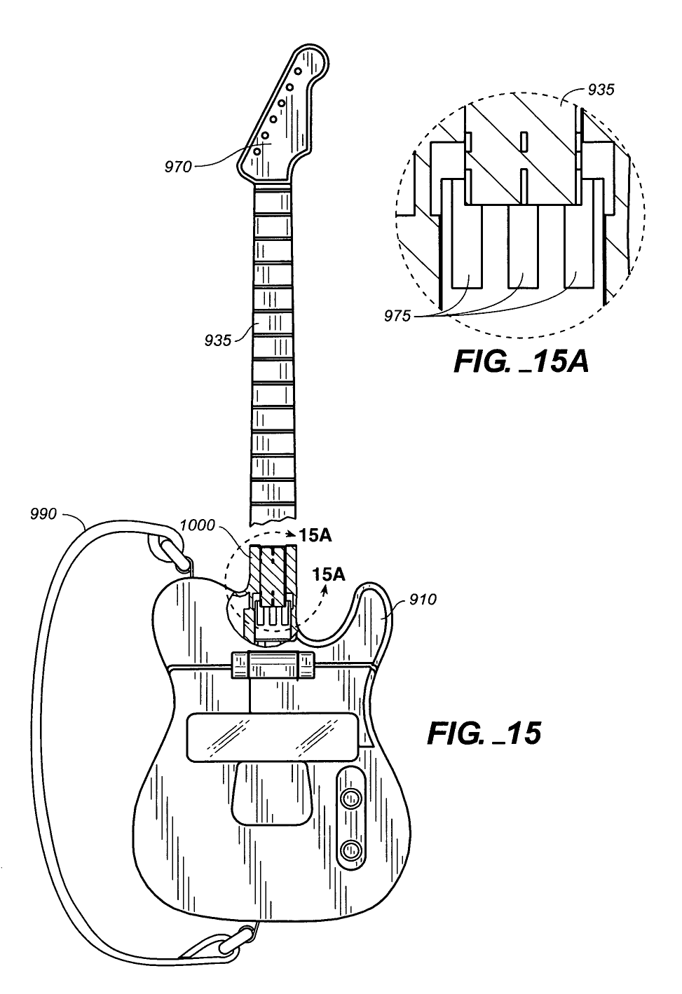

FIGS. 12 and 13 are, respectively, front and rear perspective views of the second preferred embodiment of the cellular telephone housing showing the face plate 805 flipped open via the hinge assembly 815. The face plate underside 860 is exposed to reveal a second liquid crystal display 865. The housing body front panel 810, includes rows of apertures 870, preferably substantially ovoid, to accommodate a plurality of interior function buttons 875 commonly found on cellular telephones. Positioned slightly above the rows of apertures is a large aperture 880, again preferably ovoid, for accommodating a large interior function button 885.

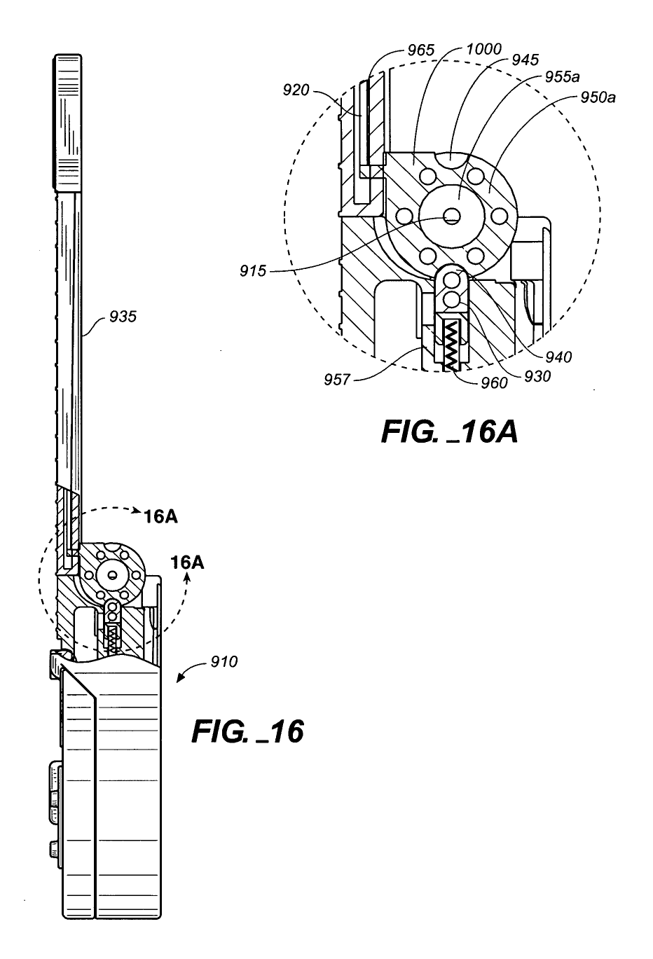

FIGS. 14-16A show a third preferred embodiment 900 of the cellular phone housing of the present invention. These views also shows details of the pivotal electrical connection between the retractable assembly 935 and the housing body 910. Specifically, retractable assembly 935 houses the antenna 920 for receiving and transmitting signals, as well as the earpiece speaker or microphone 925 for audio communication.

The retractable assembly 935 is pivotally attached to the housing body 910 at the retractable assembly receptacle, as in the above-described first and second preferred embodiments, by using a pivot pin (not shown), inserted through a pivot pin hole 915 in both the receptacle 1000 and the retractable assembly base 955. The retractable assembly is indexed in the retracted and extended, or open and closed, positions via a slide block detent 930 having a domed end 940 for slidable insertion into conforming semi-circular notches 945 in both side-by-side conductive slip rings 950 and in the retractable assembly base 955. The slide block detent resides in a pocket 957 in the cell phone housing and is urged outwardly and in line with the retractable assembly by one or more springs 960.

Signals to and from the antenna, and to the speaker or from the microphone 925, are carried via conductors 965 extending from the base 955 to the free end 970 of the retractable assembly. The conductors are connected to the slip rings, which are preferably three in number, including two outboard slip rings 950a, 950b, and a middle slip ring 950c, all of which are preferably molded into the rectractable assembly base. Alternatively, the outboard slip rings may be brought into a slidable surface-to-surface relationship with the sides 955a, 955b, of the base and the middle slip ring may be slidably inserted into a middle slot 955c formed in the retractable assembly base.

The slide block detent has embedded contacts 975 that align with the slip rings in the rectractable assembly base. The slide block contacts are connected to the cell phone via conductors, which run within the cell phone housing (not shown). The slide block conductors flex and allow the slide block to travel within its range of motion to maintain signal contact.

Depending on the selected configuration, either a microphone or a speaker 980 is disposed on the housing body front panel 985. A hand strap 990 may be provided to more perfectly replicate the appearance of a guitar, and further to provide means to hold the cellular phone without the need to grip the housing.

As will be immediately appreciated by those with skill in the art, other structural and functional elements of the third preferred embodiment are substantially similar, if not identical, to those of the first and second preferred embodiments.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A cellular telephone housing comprising:
a front panel, a back panel having a longitudinal channel, a top side panel, a bottom side panel, a right side panel, and a left side panel, said front panel including a plurality of apertures to accommodate a plurality of operating buttons and a clear window panel for displaying text;
pivoting connection means disposed on said housing body top panel;
a retractable assembly having a free end and a rotational end, said rotational end pivotally connected to said pivoting connection means, said retractable assembly shaped to recess into the longitudinal channel in said housing body back panel when not in use, and assuming a coplanar position with said housing body front panel when extended; and
a microphone or speaker disposed in said free end of said retractable assembly.

2. The cellular telephone housing of claim 1, wherein said free end of said retractable assembly houses a microphone.

3. The cellular telephone housing of claim 1, further including an antenna housed in said retractable assembly.

4. The cellular telephone housing of claim 1, wherein said free end of said retractable assembly contains a transducer which is a speaker for an earpiece.

5. The cellular telephone housing of claim 1, further including a face plate hingedly connected to said front panel.

6. The cellular telephone housing of claim 5 wherein said face plate has a top side and contains a plurality of functional buttons and a Liquid Crystal Display screen on said top side.

7. The cellular telephone housing of claim 5 wherein said face plate contains a Liquid Crystal Display screen on said underside.
